(19) United States
(12) Patent Application Publication
(10) Pub. No.: US 2015/0099238 A1
(43) Pub. Date: Apr. 9, 2015

(54) RETRIEVABLE DETENT RETAINED DENTAL PROSTHESIS SYSTEM AND METHODS

(71) Applicant: Milka Chesler, Ashkelon (IL)

(72) Inventor: Milka Chesler, Ashkelon (IL)

(21) Appl. No.: 14/510,102

(22) Filed: Oct. 8, 2014

Related U.S. Application Data
(60) Provisional application No. 61/888,268, filed on Oct. 8, 2013.

(51) Int. Cl. A61C 13/225; A61C 3/02; A61C 5/08; A61C 8/00

(52) U.S. Cl. CPC A61C 13/225; A61C 8/0066; A61C 3/02; A61C 5/08
USPC 433/165; 433/201.1; 433/180; 433/221; 433/220

(57) ABSTRACT

The disclosure relates to dental prostheses assemblies. Specifically, the disclosure relates to retrievable detent-retained dental prostheses assemblies, kits and methods of their use in the restoration and rehabilitation.

### BACKGROUND

The present disclosure is directed to retrievable dental prostheses assembly. Specifically, the disclosure is directed to a retrievable detent-retained dental prosthesis assembly system, kits and methods of use.

A “post and core” is a dental restoration system used to sufficiently build-up tooth structure for future restoration with a crown. Typically a thin rigid post is inserted into the root canal and this post provides retention for a “core” which serves as the basis for a build-up of material that replaces the lost tooth structure. The post can be cemented or screwed within the root canal and the core, which is an artificial preparation, provides retention for the crown or coping replacing the tooth. The term “post and core” is also referred to as “post-and-core” and “inlay core”. Post and core restorations can also be characterized as “foundation restorations”.

Compromised teeth can be difficult to restore for a variety of reasons. Restoration with cast metal posts can cause wedging forces apically that may result in irreversible failure because of fracture of an already weakened root. Likewise, the geometry of the flared canal can result in a very wide, tapered and non-retentive post. Under these circumstances, using a prefabricated rigid post can result in the excess space within the root canal being taken up with a bulk of luting cement, which consequently may lead to a potentially weak area in the restoration. Thus, these traditional methods of restoration can be unsatisfactory and may result in extraction of the tooth. Furthermore, the retrievability (in other words, the ability to retrieve an otherwise undamaged) of metal posts, especially the cast posts and core system can be difficult and may involve removal of tooth structure around the post, which could further weaken the tooth or the prosthesis attached to the post.

Moreover, with current post and core systems, upon failure of any component of the dental prosthesis comprised of the post, core and prosthesis (e.g., a crown), retrieval is handled through drastic decoupling of the system's components, which often leads to the loss of the prosthesis. Likewise, when bridges are installed on a combination of natural teeth via root canals as well as implants, any failure of any side of the bridge foundations, retrieving the bridge also often leads to destruction of the prosthesis.

Accordingly, if the endodontic treatment fails and/or the post fractures, it would be beneficial for the clinician to retrieve the post without substantial loss of tooth or demolishing the prosthesis attached to the post.

### SUMMARY

Disclosed, in various embodiments, are a retrievable detent-retained dental prosthesis assembly systems, kits and methods of use.

In an embodiment, provided herein is a retrievable detent-retained dental prosthesis assembly comprising: a flanged intraradicular anchor portion wherein the flanged anchor portion comprises a flanged elongated member having a distal closed tapered end and an open proximal end defining an axially extending bore therein, configured to releasably engage a detent-retained dental prosthesis; a detent comprising a head portion and a body portion configured to be releasably coupled to the anchor; and a collar operably coupled to the detent, the collar having a bore axially extending therethrough and configured to receive the body portion of the detent.

In another embodiment, provided herein is a method of performing restoration of residual roots with either insufficient or no coronal material left comprising: in an endodontically treated root canal, cementing intraradicular anchor portion wherein the anchor portion comprises a flanged elongated member having a distal closed tapered end and an open proximal end defining an axially extending bore therein, configured to releasably engage a detent-retained dental tooth crown; providing a collar operably coupled to the detent, the collar having a bore axially extending therethrough and configured to receive a body portion of a detent operably coupled to the dental tooth crown and to the detent comprising a head portion and a body portion, the detent configured to be releasably coupled to the anchor; and releasably engaging the detent and the cemented intraradicular anchor.

In yet another embodiment, provided herein is a kit for dental restoration, rehabilitation or a combination thereof comprising: a flanged intraradicular anchor portion wherein the flanged anchor portion comprises a flanged elongated member having a distal closed tapered end and an open proximal end defining an axially extending bore therein, configured to releasably engage a detent-retained dental prosthesis; a detent comprising a head portion and a body portion configured to be releasably coupled to the anchor; a collar operably coupled to a dental prosthesis the collar having a bore axially extending therethrough and configured to receive the body portion of the detent configured to be coupled to the detent; packaging; and optionally, instructions.

These and other features of the retrievable detent-retained dental prosthesis will become apparent from the following detailed description when read in conjunction with the drawings, which are exemplary, not limiting.

### BRIEF DESCRIPTION OF THE FIGURES

A better understanding of retrievable detent-retained dental prosthesis, with regard to the embodiments thereof, reference is made to the accompanying drawings, in which like numerals designate corresponding elements or sections throughout and in which:

FIG. 1 is an illustration of an embodiment of the device components;

FIG. 2, is an illustration of the device used for restoration of a detent-retained crown;

FIG. 3, is an illustration of the use of the device in the lower jaw of a patient; and

FIG. 4, is an illustration of a side view (4A), and bottom view (4B) of an embodiment of the flange of the intraradicular anchor.

### DESCRIPTION

Provided herein are embodiments of dental prostheses assembly systems. Specifically, provided are embodiments of retrievable detent-retained dental prosthesis system, kits and methods of use.

The disclosure relates to a device that allows a clinician to screw or otherwise operably couple crowns and/or bridges and other similar dental prosthesis to natural roots previously treated endodontically (e.g., the root canal procedure whereby the nerve of the tooth is removed by the dentist), thus making it possible to retrieve crowns/bridges easily from the supporting teeth.

To be effective, the post system selected should be such that if the endodontic treatment fails or the post fractures, it is easy for the clinician to retrieve the post without substantial loss of tooth structure. Unfortunately, the retrievability of a metal post, especially in the case of the cast post and core system can be difficult and may involve removal of tooth or other restored dental prosthesis structure around the post, which could further weaken the tooth. In an embodiment, in the devices, assemblies kits and methods described, the intraradicular portion can be changed without the need to discard the crown (or other similar prostheses), enabling rehabilitation of the root canal treatments or treat root caries without having to make a new crown and/or bridge, or other similar dental prosthesis, and can provide substantial control on bridges especially in cases of de-cementation of one or more restorations from the abutments.

Accordingly and in an embodiment, provided herein is a retrievable detent-retained dental prosthesis assembly comprising: a flanged intraradicular anchor portion wherein the flanged anchor portion comprises a flanged elongated member having a distal closed tapered end and an open proximal end defining an axially extending bore therein, configured to releasably engage a detent-retained dental prosthesis; a detent comprising a head portion and a body portion configured to be releasably coupled to the anchor; and a collar operably coupled to the detent, the collar having a bore axially extending therethrough and configured to receive the body portion of the detent. When coupled to a dental prosthesis, the dental prosthesis portion directly above the bore in the collar, will also have a concentrically aligned bore configured to receive the head of the detent.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection.

Also, the term “detent” refers to a device for positioning and holding one mechanical part in relation to another so that the device can be released by force applied to one and/or both of the parts. In other words, a detent can serve as a device/member/part that locks or unlocks a movement, in the case of the present disclosure the rotational movement being generated by force applied to the dental prosthesis. Likewise, the term “releasably engage” refers to the detent being engaged to the anchoring member in manner such that the detent may also be disengaged from the anchoring member and the term engage and various forms thereof, when used with reference to retention of the detent, refer to the application of any forces that tend to hold a detent and an anchor together against inadvertent or undesired separating forces (e.g., such as may be introduced during mastication). It is to be understood, however, that engagement does not in all cases require an interlocking connection that is maintained against every conceivable type or magnitude of separating force.

The detent used in the assemblies, devices, methods and kits for providing retrievable detent-retained dental prosthesis provided herein, can have a head portion having a cross section defining an area that is larger than the cross section defined by the body portion of the detent and can be, for example, a screw, a quick release detent pin, or a detent comprising at least one of the foregoing, configured to inhibit rotational movement of the dental prosthesis (e.g., any one or more of a wide variety of dental superstructures, such as a crown, (that can be attached to more than one anchor). The detent can be a screw having a distal threaded body portion and a textured proximal head portion, whereby the threaded portion can be configured to mate with a female portion embedded in the flanged anchor portion, while the textured head portion can be configured to operably couple to a collar portion operably coupled to the dental prosthesis. Likewise, the detent can be any stud or boss having a head portion and a body portion configured to releasably engage the flanged intraradicular anchor portion, for example a quick release detent pin having a non-cylindrical cross section along the longitudinal axis of the detent having steel balls and springs between them, embedded in the distal portion of the detent, aligned to protrude through holes in the detent body's periphery and compress into reciprocating grooves in the bore embedded in the flanged intraradicular anchor portion. Moreover, the detent head and or body portions may have the same or varying axial thickness. For example, the detent may be comprised of a proximal head portion that is has a cross section defining an area that is larger than the area defined by the lower distal body portion. In other words, the detent (e.g., a screw) can define a head portion having a shoulder over a lower distal portion wherein the diameter of the head portion is larger than the diameter of the bottom distal (threaded e.g.) portion. A person skilled in the art would recognize that the length, cross sectional area, and shape of head portion may vary based on the dental prosthesis used.

In an embodiment, the collar member coupled to the dental prosthesis, which can be configured to be selectively releasable from the detent, can define a bore therethrough (in other words, the bore spans the axial length of the dental prosthesis), with the bore being larger than the diameter of the detent body portion configured to releasably engage the flanged intraradicular anchor portion and smaller than the diameter of the proximal head portion of the detent, thus engaging the detent and the flanged intraradicular anchor portion can releasably couple the collar member and dental prosthesis to the flanged intraradicular anchor portion. Likewise, when using a quick release detent with the compressible protrusions disposed at the detent's distal-most end, the bore in the collar member may have a cross section that matches the shape of the cross section of the quick release detent while being smaller than the head portion of the quick release detent, thus leading to the same results.

Designs for the flanged intraradicular portion can be classified according to its size. The closed distal end may be parallel, tapered, or parallel and tapered combination. In the parallel tapered design, the closed distal end can be parallel throughout its length except for the most apical portion, where it is tapered, and thereby permitting preservation of the dentin at the apex and can achieve sufficient retention because of the parallel design. Moreover, the material used for the closed distal end can have physical properties similar to that of dentin, be bonded to the tooth structure, and be biocompatible in the oral environment. In addition, the closed distal end can act as a shock absorber during mastication, limiting the stress acting on the detent-retained prosthesis. That material can for example be carbon fiber, or fiber reinforced resin. In an embodiment, the tapered closed distal end of the flanged intraradicular anchor used in the assemblies, devices, methods and kits for providing retrievable detent-retained dental prosthesis provided herein, can be an anatomically shaped portion disposed above an elongated body dimensioned for fitting in at least a lower section thereof into an endodontically treated root canal.

A person skilled in the art would recognize that for the purposes of the present disclosure, directional or positional terms such as “top”, “bottom”, “upper,” “lower,” “side,” “front,” “frontal,” “forward,” “rear,” “rearward,” “back,” “trailing,” “above,” “below,” “left,” “right,” “horizontal,” “vertical,” “upward,” “downward,” “outer,” “inner,” “exterior,” “interior,” “intermediate,” “distal”, “proximal” etc., are merely used for convenience in describing the various embodiments of the retrievable detent-retained dental prostheses. The term “flanged” simply meaning that there is a flange thereon.

Retention performance of the retrievable detent retained prostheses assemblies described herein, depend in certain embodiments on the flanged intraradicular anchor portion, its cement, and its close adaptation to the canal wall for its retention.

The elongated member of the flanged intraradicular anchor having a distal closed tapered end and an open proximal end defining an axially extending bore therein as used in the assemblies, devices, methods and kits for providing retrievable detent-retained dental prosthesis assemblies provided herein, can be comprised of a thermoplastic polymer, having a rigid cylinder axially embedded therein defining the bore, wherein the cylinder does not extend the full length of the elongated member. As used herein, the term “embedded” refers to the cylinder being coupled firmly within a surrounding structure, or enclosed snugly or firmly within a material or structure to provide an appropriate mating surface to the detent, capable of engaging the detent. Accordingly the embedded cylinder may be metal or other similarly rigid material that can be, for example threaded or have depressions or grooves configured to receive the radially biased protrusions on the distal-most end of the detent.

In another embodiment, the anchor's distal end is open, and the detent is a screw configured to extend through the intraradicular anchor and actively engage the endodontically treated root canal directly, thereby actively connecting the prosthesis and the root canal. Thus, the flanged anchor can be coupled to the endodontically treated root canal in a passive manner, in other words by cementing the elongated body portion of the flanged anchor to the root canal, while the screw-retained prosthesis extends through the flanged portion, threading through and extending beyond to actively engage the root canal.

The flanged portion can be dimensioned to have the shape and cross sectional area of the underside of the collar, referring to the side of the collar abutting the flange portion of the intraradicular anchor. Therefore, the flange can be configured to provide support surface for the collar portion and can be configured to have a cross sectional area that is smaller than the cross sectional surface area of the endodontically treated root canal at the gum line. Moreover, the flange can comprise spatial orientation means (e.g., a channel(s), etching(s), protrusion(s) and depression(s)) indicating the radial orientation of the dental prosthesis once fully engaged by the detent. Accordingly, upon retrieving the prosthesis, for example upon cement failure of the flanged anchor portion, the marking(s) can be used to inform the attending clinician of the proper radial orientation of the flanged anchor to ensure proper orientation of the prosthesis once reengaged. Also, the term “spatial orientation” refers to the physical position of the flanged portion as well as that portion's angle, tilt, azimuth relative to the centerline of adjacent teeth, or other characteristics.

Flange portion's spatial orientation refers in an embodiment to the orientation of the flange in relation to the line joining the center of the adjacent teeth on both sides of the tooth sought to be restored. For example, the orientation means can be a pair of protrusions configured to extend below the flange and extend axially at 180° to each other and be configured to engage a bore drilled into the endodontically treated root canal using, for example a dedicated drill bit. A skilled person would readily recognize that there are many configurations for the protrusions that would facilitate spatial orientation of the

The dental restoration processes, for example, replacing a missing tooth or teeth with permanent prostheses mounted on the flanged intraradicular anchor portion embedded in the endodontically treated root canal, can be done using the assemblies, devices, methods and kits for providing retrievable detent-retained dental prosthesis provided herein. Fixed prostheses can be fixed to the flanged anchor in a nominally permanent manner, and may still not be designed to be removed in the normal use thereof. These quasi-permanent prostheses are contrasted with removable or implant-only-supported prostheses, the former (removable), which are removable during normal use thereof and may or may not have an implant structure in the mouth. Both the fixed and mobile permanent prostheses can provide the appearance of teeth, and mimic the function thereof. In an embodiment, the dental prosthesis a removable/retrievable full dental prostheses (e.g., bridge), a crown, or a combination comprising one or both of the foregoing. The prostheses therefore can use both implants and root canal combination to provide support for the prostheses and the dental prosthesis is a tooth crown, a partial arch bridge, a full arch bridge or a combination comprising one of the foregoing.

In an embodiment, the devices and assemblies described hereinabove are used in the methods and kits provided herein. If insufficient dentine remains the devices and kits provided herein can be used for the restoration.

Accordingly and in an embodiment, provided herein is a method of performing restoration of residual roots with either insufficient or no coronal material left comprising: endodontically treating the root; cementing intraradicular anchor portion wherein the anchor portion comprises a flanged elongated member having a distal closed tapered end and an open proximal end defining an axially extending bore therein, configured to releasably engage a detent-retained dental tooth crown; providing a collar operably coupled to the detent, the collar having a bore axially extending therethrough and configured to receive a body portion of a detent operably coupled to the dental tooth crown and to the detent comprising a head portion and a body portion, the detent configured to be releasably coupled to the anchor; and releasably engaging the detent and the cemented intraradicular anchor.

Likewise, the kits provided herein can be used to facilitate the methods described herein. Accordingly, provided herein is a kit for dental restoration, rehabilitation or a combination thereof comprising: a flanged intraradicular anchor portion wherein the flanged anchor portion comprises a flanged elongated member having a distal closed tapered end and an open proximal end defining an axially extending bore therein, configured to releasably engage a detent-retained dental prosthesis; a detent comprising a head portion and a body portion configured to be releasably coupled to the anchor; a collar operably coupled to a dental prosthesis the collar having a bore axially extending therethrough and configured to receive the body portion of the detent configured to be coupled to the detent; packaging; and optionally, instructions.

The kits provided can comprise, for example, a plurality of primary drill bits of several diameters and lengths, configured to prepare the bore in the root canal for receiving the flanged intraradicular portion (e.g., L₁D₁, L₂D₂, and L₃D₃). In addition, the kits provided can comprise a plurality of flanged intraradicular sizes configured to be coupled to the bores made by the drill bits by cementing (e.g., l₁d₁, l₂d₂, and l₃d₃). Additionally, the kits can comprise one or more secondary drill bits configured to create the slots or bores used for the spatial orientation means coupled to the flanged intraradicular portion. Likewise the kits can comprise cement or ingredients used in making the cement and other ingredients configured to facilitate the restoration, installation, or retrieval of the prosthesis.

A more complete understanding of the assemblies, processes, methods, kits and devices disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

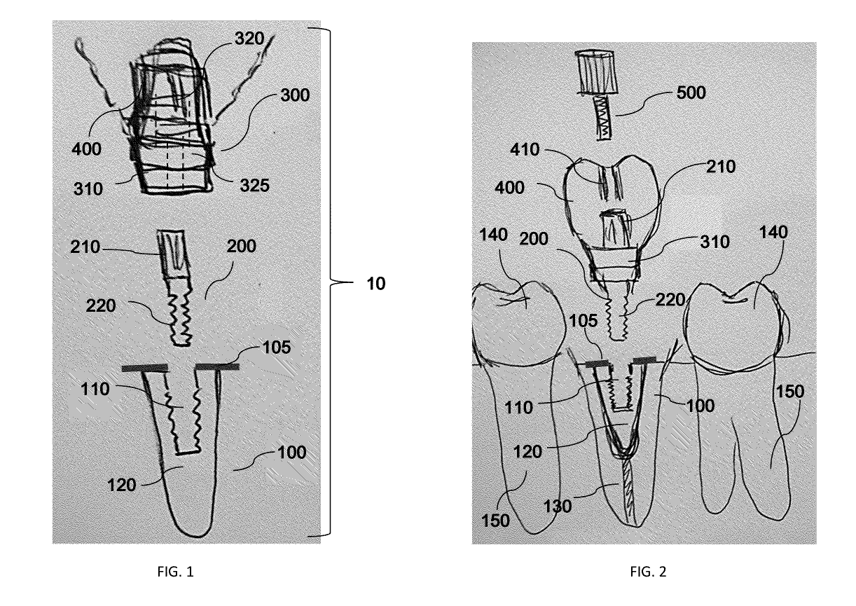

Turning now to FIG. 1, illustrating an exploded view of the retrievable detent-retained dental prosthesis assembly system 10 described herein. As illustrated flanged intraradicular anchor portion 100 comprising flanged elongated member having distal closed tapered end 120 and open proximal end defining an axially extending bore 110 therein with flange 105 thereon, configured to releasably engage detent 200 retained dental prosthesis 400; detent 200 configured to be releasably coupled to flanged intraradicular anchor 100; and collar member 300 capable of being operably coupled to detent 200. Also shown in FIG. 1, is head portion 210 and lower body portion 220 of detent 200, where lower portion 220 configured to releasably engage bore 110 defined in flanged intraradicular elongated anchor member 100, while head portion 210 configured to operably couple to collar member 300, having lower collar portion 310 having a bore axially extending therethrough, the bore comprising proximal head portion 320 defining an axial cross section that is larger than distal bore portion 325, wherein the head portion configured to receive the detent head portion 210 and the distal bore portion 325 configured to receive the detent body portion 220 but have axial cross section that is smaller than the detent head portion 210, thus preventing the detent head portion 210 from entering distal bore portion 325. Collar member 300 can be operably coupled to dental prosthesis 400, for example a tooth crown.

Turning now to FIG. 2, illustrating an embodiment of the assembly described herein wherein, elongated flanged intraradicular anchor 100 having anatomically shaped closed tapered distal end 120 cemented in an endodontically treated root canal 130, exposing proximal, axially extending bore 110 having flange 105 thereon, configured to engage lower portion 220 of detent 200. As illustrated in the embodiment, head portion 210 of detent 200 is operably coupled to lower collar portion 310 of collar member 300 supporting dental prosthesis 400. Prosthesis 400 defines a bore 410 configured to receive securing means 500 (e.g., a screw driver, (dedicated) tool and the like), configured to releasably engage head portion 210 of detent 200, thus retrievably securing collar member 300 to flanged intraradicular anchor portion 100. Also shown in FIG. 2 are natural teeth 140 having live (not endodontically treated) roots 150.

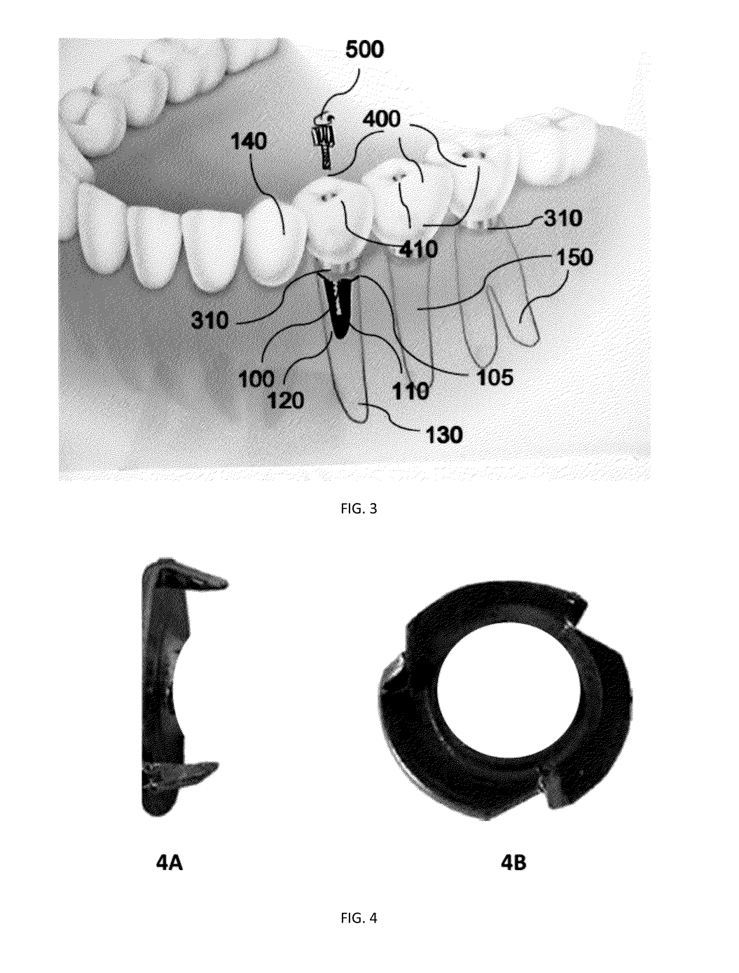

Turning now to FIG. 3, illustrating the restoration process disclosed herein where elongated flanged intraradicular anchor 100 having anatomically shaped closed tapered distal end 120 cemented in endodontically treated root canal 130, with proximal, axially extending bore 110 having flange 105 thereon, engaging lower body portion 220 of detent 200. As illustrated, head portion 210 (not shown, see e.g., FIG. 2) of detent 200 is operably coupled (e.g., via proximal bore portion 320 (not shown, see e.g., FIG. 1) to lower collar portion 310 of collar member 300 supporting dental prosthesis 400. Prostheses 400 define bore(s) 410 configured to receive securing means 500 (e.g., a screw), configured to releasably engage head portion 210 of detent 200, thus securing dental prosthesis 400 to collar member 300 and intraradicular anchor portion 100. Also shown in FIG. 3 are original prosthetic teeth 400 having live (not endodontically treated) roots 150 and collar member collar 310, supporting dental prostheses 400 (e.g., a tooth crown).

For example, Vickers hardness is measured on the surface in contact with the stainless steel sheet using a micro-indentation tester (Shimadzu Micro Hardness Testers HMV-2, Shimadzu Corporation, Kyoto, Japan) with a 100 g load applied for 45 s. The specimens are individually fixed in a clamping apparatus and positioned in such a way that the test surface is kept perpendicular to the indentator. Measurements are accomplished at depths of 0.4 mm, 1.0 mm, 2.0 mm and 2.6 mm from the upper surface of specimen. In each sample, three indentations are equally spaced over a circle and not closer than 1 mm to the adjacent indentations or the margin of the specimen are taken at the all predetermined depths and the averaged is then calculated. Then, for each tested material, a microhardness mean value is determined at the specified depths of cure. The flanged intraradicular anchor can have Vickers Pyramid No. (Hv) equal to or greater than 35, for example, Hv of between about 35 and 180 (e.g., stainless steel) for example, Hv between about 35 and 150 (e.g., for glass ionomer resin cemented bi-axially oriented carbon fiber anchor).

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “plurality”, as used herein, is defined as two or as more than two. The term “another”, as used herein, is defined as at least a second or more. The terms “including” and/or “having”, as used herein, are defined as comprising (i.e., open language).

In an embodiment, provided herein is a retrievable detent-retained dental prosthesis assembly comprising: a flanged intraradicular anchor portion wherein the anchor portion comprises an elongated member having a distal closed tapered end and an open proximal end defining an axially extending bore therein, configured to releasably engage a detent-retained dental prosthesis; a detent comprising a head portion and a body portion configured to be releasably coupled to the anchor; and a collar operably coupled to the detent, the collar having a bore axially extending therethrough and configured to receive the body portion of the detent while preventing passage of the detent head portion, wherein (i) the detent is a screw, a quick release detent pin, or a detent comprising at least one of the foregoing, configured to inhibit rotational movement of the collar member, (ii) the flange of the flanged anchor defines an axial cross section that is smaller than the surface cross section of the root canal at the gum line, (iii) the collar member is configured to be selectively releasable from the detent, (iv) the anchor is cemented to the endodontically treated root canal, (v) the flanged elongated member is comprised of a thermoplastic polymer, having a rigid cylinder axially embedded therein defining the bore, wherein the cylinder does not extend the full length of the elongated member, (vi) the rigid cylinder defines an internal thread or interrupted thread, (vii) the collar member is operably coupled to the dental prosthesis, wherein (viii) the dental prosthesis defines a bore therein configured to receive the detent or screw head portion, (ix) the dental prosthesis is a tooth crown, a partial arch bridge, a full arch bridge or a combination comprising one of the foregoing, (x) the flanged intraradicular portion further comprises spatial orientation means, (xi) the flanged intraradicular anchor has a surface Vickers microhardness (Hv) that is equal to or greater than about 35, (xii) the flanged intraradicular anchor has a surface Vickers microhardness (Hv) that is between about 35 and 180, and wherein (xiii) the spatial orientation means are two protrusions coupled to the flange at 180° to each other, extending towards the anchor's distal end.

In another embodiment, provided herein is a method of performing restoration of residual roots with either insufficient or no coronal material left comprising: in an endodontically treated root canal, cementing a flanged intraradicular anchor portion wherein the anchor portion comprises an elongated member having a distal closed tapered end and an open proximal end defining an axially extending bore therein, configured to releasably engage a detent-retained tooth crown, wherein the flange is aligned with the gum line; providing a collar member operably coupled to the dental tooth crown, wherein the collar is having a bore axially extending therethrough, the bore configured to receive a body portion of the detent while preventing passage of a head portion of the detent; aligning the bore in the collar member with the bore in the flanged intraradicular anchor; and releasably engaging the detent to the cemented flanged intraradicular anchor through the bore in the collar member, wherein (xiv) the detent is a screw, a quick release detent pin, or a detent comprising at least one of the foregoing, configured to inhibit rotational movement of the collar member, (xv) the flange of the flanged anchor defines an axial cross section that is smaller than the surface cross section of the root canal at the gum line, (xvi) the collar member is configured to be selectively releasable from the detent, (xvii) the anchor is cemented to the endodontically treated root canal, (xviii) the flanged elongated member is comprised of a thermoplastic polymer, having a rigid cylinder axially embedded therein defining the bore, wherein the cylinder does not extend the full length of the elongated member, (xix) the rigid cylinder defines an internal thread or interrupted thread, (xx) the collar member is operably coupled to the dental prosthesis, wherein (xxi) the dental prosthesis defines a bore therein configured to receive the detent or screw head portion, (ix) the dental prosthesis is a tooth crown, a partial arch bridge, a full arch bridge or a combination comprising one of the foregoing, (xxii) the flanged intraradicular portion further comprises spatial orientation means, (xxiii) the flanged intraradicular anchor has a surface Vickers microhardness (Hv) that is equal to or greater than about 35, (xxiv) the flanged intraradicular anchor has a surface Vickers microhardness (Hv) that is between about 35 and 180, and wherein (xxv) the spatial orientation means are two protrusions coupled to the flange at 180° to each other, extending towards the anchor's distal end.

In another embodiment, provided herein is a kit for dental restoration, rehabilitation or a combination thereof comprising: a flanged intraradicular anchor portion wherein the anchor portion comprises an elongated member defining an axially extending bore therein, configured to releasably engage a detent-retained or screw-retained dental prosthesis; a detent or screw comprising a head portion and a body portion configured to be releasably coupled to the anchor; a collar operably coupled to the detent or screw, the collar is having a bore axially extending therethrough, the bore configured to receive a body portion of the detent or screw while preventing passage of a head portion of the detent or screw; a plurality of primary drill bits configured to create a borehole in a root canal configured to receive the flanged intraradicular anchor portion; optionally, a secondary drill bit configured to create a slot for spatial orientation means coupled to the flanged intraradicular portion; packaging; and optionally, instructions, wherein (xxvi) the detent is a screw, a quick release detent pin, or a detent comprising at least one of the foregoing, configured to inhibit rotational movement of the collar member, (xxvii) the flange of the flanged anchor defines an axial cross section that is smaller than the surface cross section of the root canal at the gum line, (xxviii) the collar member is configured to be selectively releasable from the detent, (xxix) the anchor is cemented to the endodontically treated root canal, (xxx) the flanged elongated member is comprised of a thermoplastic polymer, having a rigid cylinder axially embedded therein defining the bore, wherein the cylinder does not extend the full length of the elongated member, (xxxi) the rigid cylinder defines an internal thread or interrupted thread, (xxxii) the collar member is operably coupled to the dental prosthesis, wherein (xxxiii) the dental prosthesis defines a bore therein configured to receive the detent or screw head portion, (xxxiv) the dental prosthesis is a tooth crown, a partial arch bridge, a full arch bridge or a combination comprising one of the foregoing, (xxxv) the flanged intraradicular portion further comprises spatial orientation means, (xxxvi) the flanged intraradicular anchor has a surface Vickers microhardness (Hv) that is equal to or greater than about 35, (xxxvii) the flanged intraradicular anchor has a surface Vickers microhardness (Hv) that is between about 35 and 180, and wherein (xxxviii) the spatial orientation means are two protrusions coupled to the flange at 180° to each other, extending towards the anchor's distal end.

In yet another embodiment, provided herein is a retrievable screw-retained crown assembly comprising: a flanged intraradicular anchor portion wherein the anchor portion comprises an elongated member having an open distal end and an open proximal end defining an axially extending bore therein, configured to releasably engage a screw-retained dental prosthesis, the flanged intraradicular portion further configured to be received in an endodontically treated root canal; a screw comprising a head portion and a body portion configured to be releasably coupled to the anchor; and a collar operably coupled to the screw, the collar having a bore axially extending therethrough and configured to receive the body portion of the screw while preventing passage of the screw head portion, wherein the screw is configured to extend through the flanged intraradicular portion and releasably engage the endodontically treated root canal, wherein (xxxix) the flange of the flanged anchor defines an axial cross section that is smaller than the surface cross section of the root canal at the gum line, (xl) the collar member is configured to be selectively releasable from the detent, (xli) the anchor is cemented to the endodontically treated root canal, (xlii) the flanged elongated member is comprised of a thermoplastic polymer, having a rigid cylinder axially embedded therein defining the bore, wherein the cylinder does not extend the full length of the elongated member, (xliii) the rigid cylinder defines an internal thread or interrupted thread, (xliv) the collar member is operably coupled to the dental prosthesis, wherein (xlv) the dental prosthesis defines a bore therein configured to receive the detent or screw head portion, (xlvi) the dental prosthesis is a tooth crown, a partial arch bridge, a full arch bridge or a combination comprising one of the foregoing, (xlvii) the flanged intraradicular portion further comprises spatial orientation means, (xlviii) the flanged intraradicular anchor has a surface Vickers microhardness (Hv) that is equal to or greater than about 35, (xlix) the flanged intraradicular anchor has a surface Vickers microhardness (Hv) that is between about 35 and 180, and wherein (1) the spatial orientation means are two protrusions coupled to the flange at 180° to each other, extending towards the anchor's distal end.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A retrievable detent-retained dental prosthesis assembly comprising:
a. a flanged intraradicular anchor portion wherein the anchor portion comprises an elongated member having a distal closed tapered end and an open proximal end defining an axially extending bore therein, configured to releasably engage a detent-retained dental prosthesis;
b. a detent comprising a head portion and a body portion configured to be releasably coupled to the anchor; and
c. a collar operably coupled to the detent, the collar having a bore axially extending therethrough and configured to receive the body portion of the detent while preventing passage of the detent head portion.

2. A method of performing restoration of residual roots with either insufficient or no coronal material left comprising:
a. in an endodontically treated root canal, cementing the flanged intraradicular anchor portion of claim 1 to the endodontically treated root canal wherein the flange is aligned with the gum line;
b. providing the collar member of claim 1 being operably coupled to the dental tooth crown;
c. aligning the bore in the collar member with the bore in the flanged intraradicular anchor; and
d. releasably engaging the detent of claim 1 to the cemented flanged intraradicular anchor through the bore in the collar member.

3. A kit for dental restoration, rehabilitation or a combination thereof comprising:
a. the flanged intraradicular anchor portion of claim 1;
b. a detent or screw comprising a head portion and a body portion configured to be releasably coupled to the anchor;
c. the collar of claim 1, operably coupled to the detent or screw;
d. a plurality of primary drill bits configured to create a borehole in a root canal configured to receive the flanged intraradicular anchor portion;
e. optionally, a secondary drill bit configured to create a slot for receiving spatial orientation means coupled to the flanged intraradicular portion;
f. packaging; and
g. optionally, instructions

4. A retrievable screw-retained crown assembly comprising:
a. a flanged intraradicular anchor portion wherein the anchor portion comprises an elongated member having an open distal end and an open proximal end defining an axially extending bore therein, configured to releasably engage a screw-retained dental prosthesis, the flanged intraradicular portion further configured to be received in an endodontically treated root canal;
b. a screw comprising a head portion and a body portion configured to be releasably coupled to the anchor; and
c. a collar operably coupled to the screw, the collar having a bore axially extending therethrough and configured to receive the body portion of the screw while preventing passage of the screw head portion,
wherein the screw is configured to extend through the flanged intraradicular portion and actively engage the root canal.

5. The assembly of claim 1, wherein the detent is a screw, a quick release detent pin, or a detent comprising at least one of the foregoing, configured to inhibit rotational movement of the collar member.

6. The assembly of claim 1, wherein the flange of the flanged anchor defines an axial cross section that is smaller than the surface cross section of the endodontically treated root canal at the gum line.

7. The assembly of claim 5, wherein the collar member is configured to be selectively releasable from the detent.

8. The assembly of claim 6, wherein the anchor is cemented to the endodontically treated root canal.

9. The assembly of claim 8, wherein the flanged elongated member is comprised of a thermoplastic polymer, having a rigid cylinder axially embedded therein defining the bore, wherein the cylinder does not extend the full length of the elongated member.

10. The assembly of claim 9, wherein the rigid cylinder defines an internal thread or interrupted thread.

11. The assembly of claim 1, wherein the collar member is operably coupled to the dental prosthesis.

12. The assembly of claim 1, wherein the dental prosthesis defines a bore therein configured to receive the detent or screw head portion.

13. The assembly of claim 1, wherein the dental prosthesis is a tooth crown, a partial arch bridge, a full arch bridge or a combination comprising one of the foregoing.

14. The assembly of any one of claim 1, wherein the flanged intraradicular portion further comprises spatial orientation means.

15. The assembly of claim 1, wherein the flanged intraradicular anchor has a surface Vickers microhardness (Hv) that is equal to or greater than about 35.

16. The assembly of claim 15, wherein the flanged intraradicular anchor has a surface Vickers microhardness (Hv) that is between about 35 and 180.

17. The assembly of claim 14 wherein the spatial orientation means are two protrusions coupled to the flange at 180° to each other, extending towards the anchor's distal end.
